(19) United States
(12) Patent Application Publication
(10) Pub. No.: US 2007/0007730 A1
(43) Pub. Date: Jan. 11, 2007

(54) Air riding seal

(76) Inventors: Glenn M. Garrison, Perkiomenville, PA (US); Alan D. McNickle, Sellersville, PA (US)

Correspondence Address: CHARLES N. QUINN;FOX ROTHSCHILD LLP, 2000 MARKET STREET, 10TH FLOOR, PHILADELPHIA, PA, 19103, US

(21) Appl. No.: 11/134,249

(22) Filed: Jan. 30, 2006

Related U.S. Application Data
(60) Provisional application No. 60/575,351, filed on May 28, 2004.

(51) Int. Cl. F16J 15/44

(52) U.S. Cl. 277/411

(57) ABSTRACT

A hydrostatic seal assembly used between a shaft and a housing to restrict the flow of fluid from a relatively higher pressure region in the housing to a relatively lower pressure region in the housing includes a seal runner extending radially from the shaft and having a shaft sealing surface, and a seal ring positioned around the shaft and having a sealing face surface positioned for movement toward and away from the shaft sealing surface and forming a seal gap therebetween to break down the pressure across the seal ring.

### CROSS-REFERENCE TO RELATED PATENT APPLICATION

This patent application claims the benefit, under 35 USC 119(e), of U.S. provisional patent application Ser. No. 60/575,351, filed 28 May 2004 in the name of Alan D. McNickle.

### DESCRIPTION OF THE PRIOR ART

This invention provides new capabilities for high temperature bearings and seals for TBCC applications.

Higher levels of compressor exit (T₃) and turbine inlet (T_{4.1}) temperature are key to both military and civilian advanced engine programs. Air bled from the engine is used to cool critical high temperature components particularly in the turbine. However, diverting this air to cool engine hardware rather than using in the engine cycle reduces thrust levels, lowers component efficiencies and adversely affects turbine inlet temperatures. It, therefore, becomes critical to minimize the amount of cooling air used for the turbine. Compounding this problem is coolant leakage, which results in both higher amounts of flow being bled off than is required for cooling, as well as a drop in the supply requirements for the hardware. Therefore, in order to function properly, the ability to provide and maintain sealing throughout the engine is essential.

Current gas turbine engines primarily use labyrinth knife-edge seals to meet this requirement. While these seals have been in use for many years, they have reached the limit in terms of leakage reduction. In addition, their performance deteriorates over time, resulting in even more leakage flow. Brush seals have been incorporated in one family of engines to reduce leakages. Initially, brush seals offered reduced leakages compared to the labyrinth seals. However, their performance degrades with time resulting from bristle wear as brush seals are contacting seals.

Many of these problems have been addressed by embodiments of the hydrostatic seal disclosed in U.S. Pat. No. 6,145,840 (“Pope”), issued Nov. 14, 2000, incorporated herein by reference. Pope discloses a face seal for a rotating shaft for sealing between a normally high pressure region and a normally lower pressure region. A seal ring is shaped to form a gap between the ring and a runner surface on the shaft. The gap converges in the direction of fluid flow and creates turbulent flow along a seal gap with sufficient clearance between the rotating runner and the seal ring to accommodate distortions in the ring which may occur over ring lifetime. A servo system coupled to the seal ring moves the seal ring away from the runner during low pressure differences between the regions and restores the sealing function along the seal gap when pressure difference between the regions increases sufficiently.

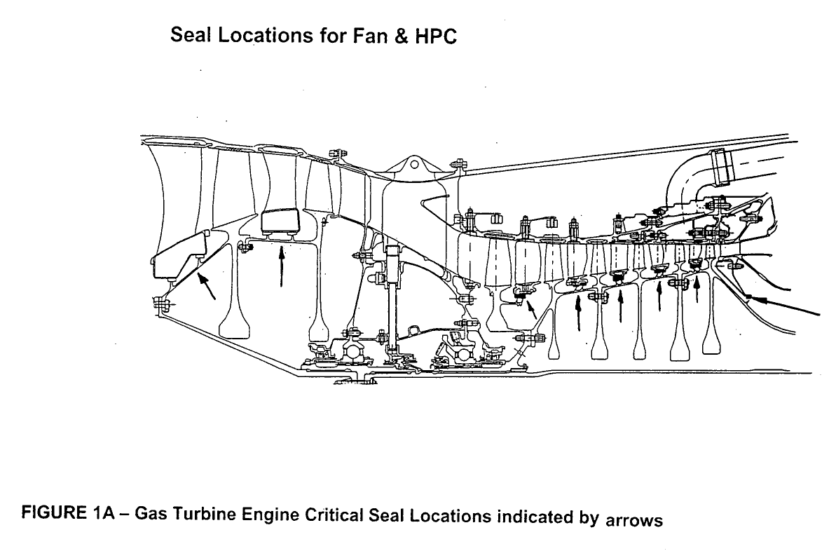

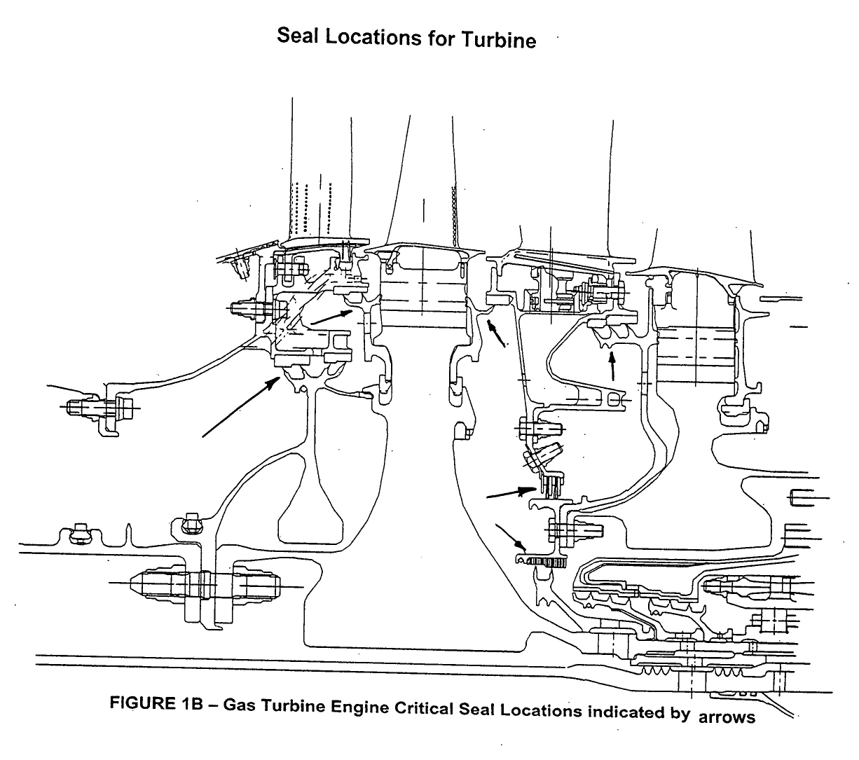

Future high speed turbine engines (Mach 4-4.2) will require high temperature (˜1500° F.) high speed (˜1500 ft/sec) and low leakage seals at critical engine locations to manage secondary flows. Some of the critical locations are shown in FIG. 1.

The ability to control secondary flow systems directly impacts component efficiencies and performance, component temperatures and thermal gradients, and component clearances over the entire operating range of the gas turbine engine. This will become even more critical as cooled cooling air (CCA) systems come into use as the cooling source temperatures (T₃) increase to meet performance targets of advanced engines, which will require reducing the temperature of the cooling air used in the flow system.

Because of high surface speed and low leakage requirements, only advanced non-contacting film-riding seals will be considered as neither high leakage labyrinth seals nor contacting brush seals are suitable. Non-contacting film-riding seals are currently being used for lower temperature/lower surface speed applications in industrial gas compressors. However, non-contacting sealing technology has not yet been demonstrated in gas turbine engine applications.

### DESCRIPTION OF THE INVENTION AND BEST MODE FOR PRACTICE THEREOF

This invention provides advanced non-contact seals that reduce secondary cooling flows and parasitic leakages so advanced engines can achieve required durability, performance and efficiency goals.

High temperature film-riding seals have been tested and the technology Readiness Level (TRL) is considered to be at level 3. This invention enhances the performance envelope and demonstrates this technology in an engine and elevate the TRL to level 6.

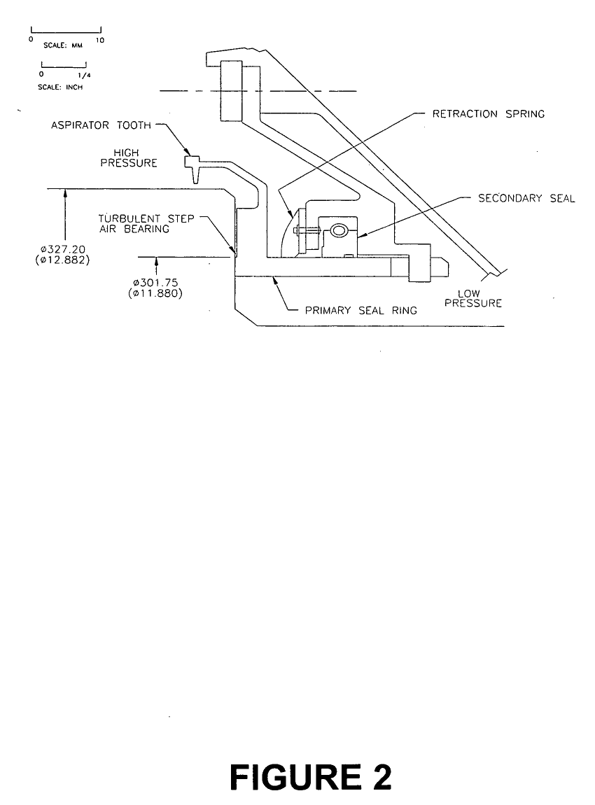

FIG. 2 schematically illustrates a non-contact seal in accordance with the invention. Pressure is applied at the outer diameter of the seal. The seal contains a retraction spring maintaining the seal in an open position until pressure is applied. When the system is energized, the aspirator tooth plenum fills; during this period unbalanced pressure across the plenum forces seal closure toward the rotor. As the seal approaches the rotor, a hydrostatic gas-film is established.

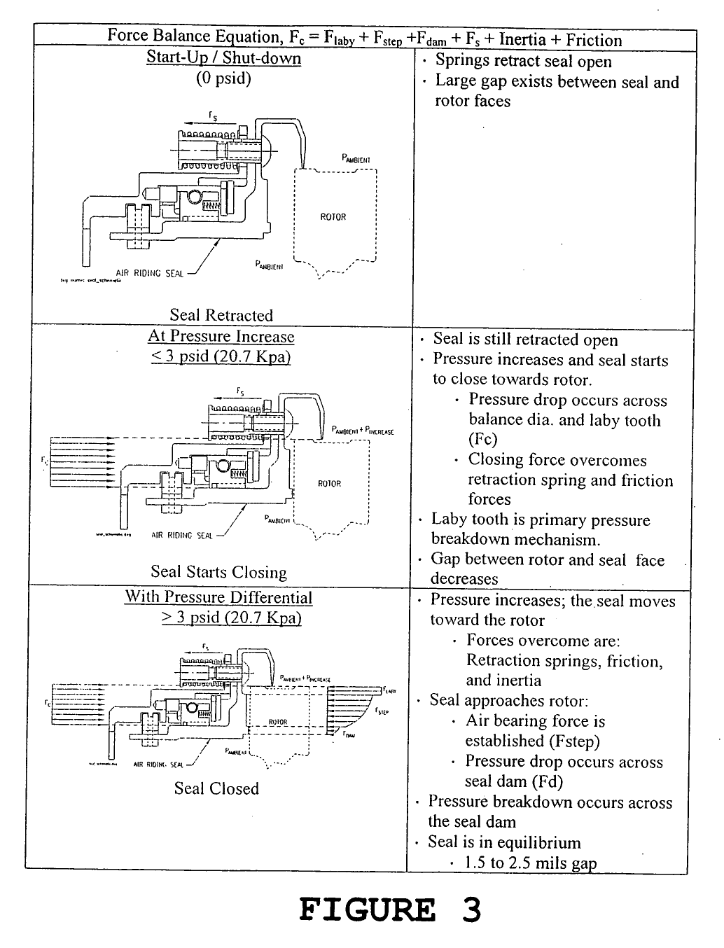

This non-contacting hydrostatic seal performance has been proven at about 1000 ft/sec., about 1000° F. and about 60 psi. The film-riding seal is a face seal that operates on a gas film clearance which is preferably on the order of 1.5-2.5 mils (0.038-0.064 mm). The gas film separates the stationary seal from the rotor by high pressure hydrostatic operation between the two faces. FIG. 3 illustrates the seal operation from start-up to full operation.

The face seal is normally retracted away from the rotor face during start-up and shut-down conditions when insufficient differential pressure exists. As pressure builds in the engine, the seal starts to close toward the rotor due to a thrust balance that develops across the area defined by the seal aspirator tooth and seal balance diameter. The seal continues to move towards the rotor until an operating gas film is established by the high pressure air flowing over the stepped seal face. The seal reaches equilibrium when the force balance is satisfied, establishing an equilibrium film thickness.

To provide gas film measurements for large size seal; it was necessary to build a static test rig for the sole purpose of assessing the gas film clearance and seal leakage. Additionally, the static test rig had a stationary rotor made from PVC, a non-conductive material. PVC was chosen to allow proper operation of the proximity probes for the gas film measurement without electrical interference.

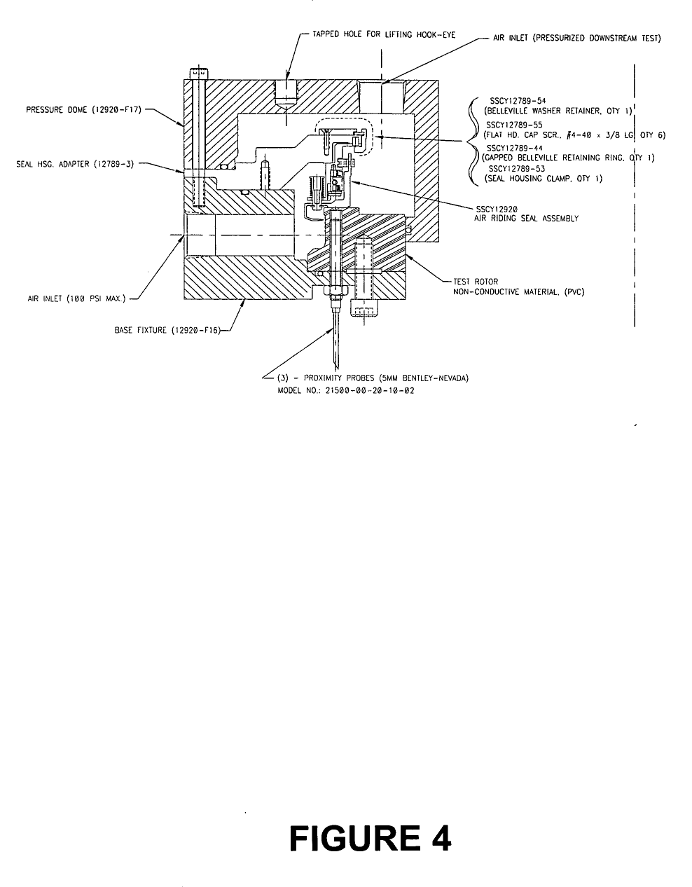

The static test rig cross-section is shown in FIG. 4. The entire large-scale seal assembly is mounted in the test rig as shown. However, during static tests, the rig assembly was repositioned (rotated 90° about the centerline) to a vertical attitude as it would be in an engine environment. Three proximity probes were mounted in the rotor, spaced equally, and aimed at the seal dam. The data from this rig produced information for Pressure vs. Leakage and Pressure vs. Film Clearance curves to validate the design code prediction. Two seal codes, TURSTV5 and JODYN are involved

TURSTV5: This seal code evaluates hydrostatics of the seal interface, uses compressible laminar and turbulent flow analysis, and includes effects of taper on the rotor, seal face step height and dam width. This code was implemented in a MS-DOS QBasic program developed specifically for the air riding seal. TURSTV5 calculates the pressures, forces and flow in a stepped hydrostatic face seal. It evaluates friction and velocity head dynamic pressure losses at the seal/rotor interface inlet and exit as well as vena-contracta at the inlet and step. The effect of the labyrinth tooth upstream of the seal face is considered as are the retraction spring forces which are adjusted as a function of clearance. The program can evaluate tapers machined in the rotor face, the seal step face and the seal dam. Tapers caused by pressure and centrifugal forces may also be inputted into the program.

JODYN: This seal code calculates dynamic response of the seal system due to rotor swash, including hydrostatic forces, inertia forces, friction forces for the secondary seal and anti-rotation locks. JODYN calculates dynamic response of the seal system as a result of rotor swash. The program calculates maximum rotor swash the seal can track without contacting the rotor. TURSTV5 is used as a subroutine to calculate the hydrostatic forces and moments for a given clearance, rotor swash and seal swash.

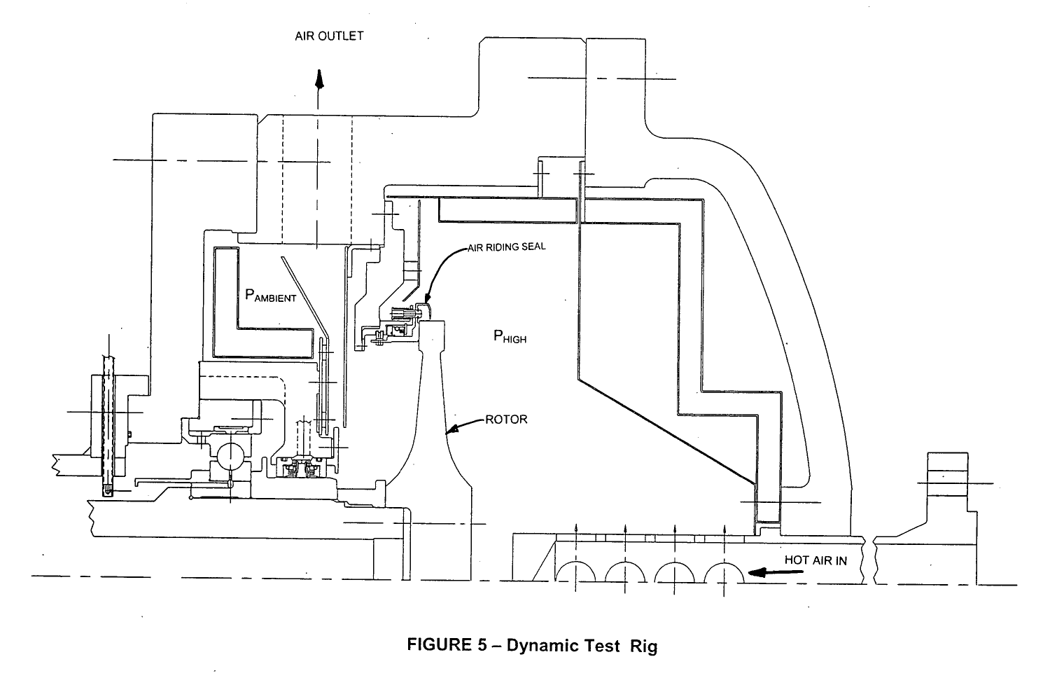

Dynamic testing was performed on a high temperature dynamic test rig as illustrated in FIG. 5.

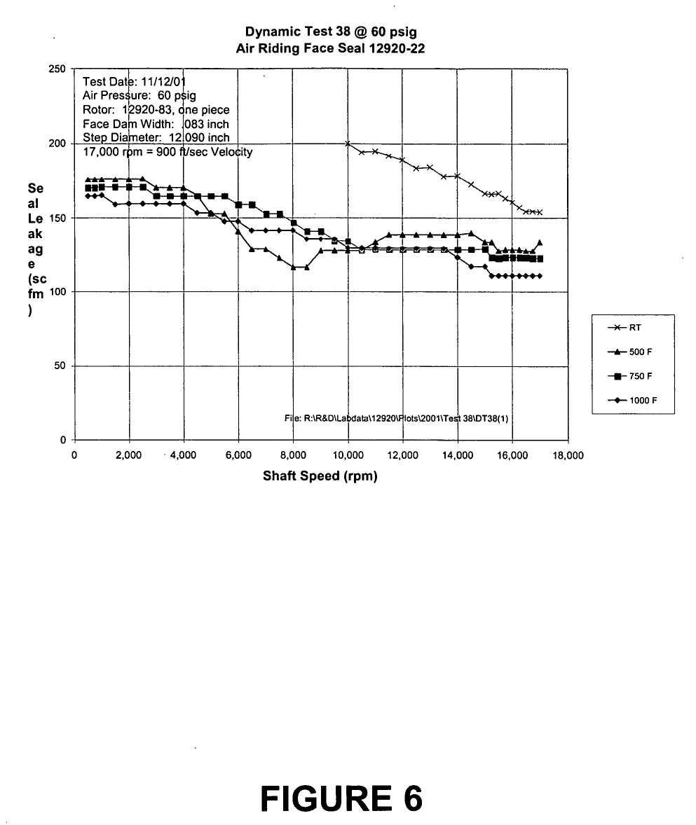

FIG. 6 illustrates seal leakage at various speed and temperature conditions. Using a leak rate of 200 scfm (0.25 lbm/sec) at 50 psid at room temperature for a 12″ diameter seal, the flow factor is estimated to be about 0.006 lb/sec.R^{0.5}/psia.in, which is within the leakage target.

Seal Vibration

The original seal revealed an un-damped natural frequency, “fₙ” excitation at shaft speeds between 15,000 and 16,000 rpm. The seal's first calculated fₙ was 11,340 cpm which was lower than the observed excitation at 16,000 rpm. Piston ring (secondary seal) and seal housing damping may contribute to the higher values in the test rig. Future seals will be designed with much higher values of “fₙ” to minimize or eliminate seal vibration.

The film-riding seal has demonstrated low leakage (flow factor: 0.006 lbs/sec.R^{0.5}/psia.in), high temperature (˜1000° F.) and high surface speed (˜1000 ft/sec) performance on the test rig in a simulated environment.

Some sea-level engine testing must be performed at an interim speed/temperature/pressure condition to demonstrate the non-contacting sealing technology and identify areas for design enhancement to reach higher goals. A new hybrid hydrodynamic/hydrostatic design should also be pursued for conditions beyond the interim target and approaching NASA's 2015 goals. In the hybrid design, the seal will operate at a large film thickness (˜0.001″) to minimize heat generation; however, the hydrodynamic features are expected to enhance film stiffness to prevent stator/rotor contacts at high speeds.

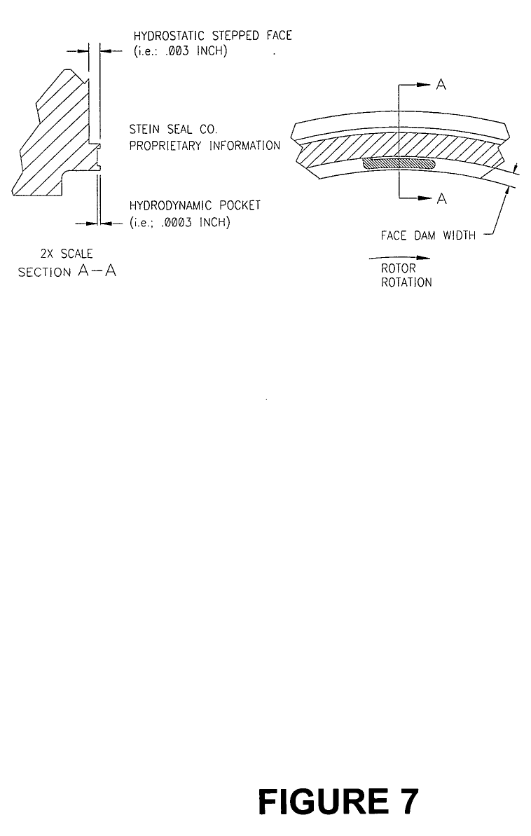

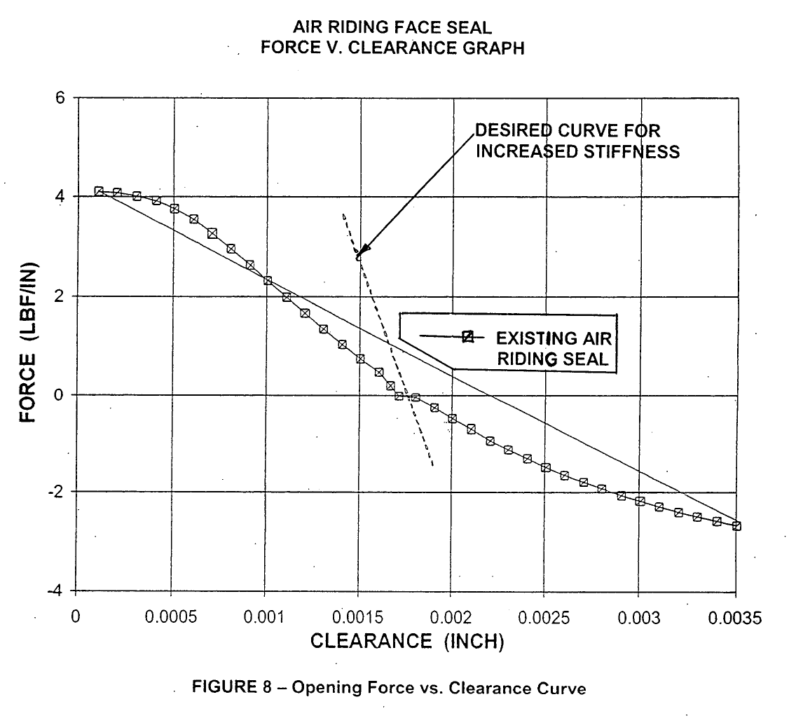

The hydrostatic seal design may be modified and optimized using various design codes. The primary focus is to enhance film stiffness, reduce vibration and demonstrate capability to handle a larger run-out and axial movement. A number of design options may be optimized as below:
Optimization of hydrostatic pockets and step dimensions;
Significantly higher natural frequency of the seal by selecting materials and designs;
Incorporation of hydrodynamic grooves in the sealing dam as shown in FIG. 7;
Orifice compensation and the like.

All the above may enhance film stiffness, which is the force necessary to move the seal by unit length (lbf/inch) closer to the rotor. The higher the film stiffness, the more difficult it will be for the seal to contact the rotor. A higher film stiffness will be necessary for higher target speeds and temperatures.

A special silicon nitride grade used for gas turbine engine rotors will be evaluated for seal because of its high modulus of elasticity, strength and thermal conductivity. The rotor can be fabricated from advanced superalloys, such as Waspaloy or MARM 247 and coated with hard coatings with solid lubricants. The high strength materials will also allow the use of reduced cross sections and hence reduced weight.

Seal size and adaptive hardware may be selected to reach the interim target surface speeds.

Candidate seal hardware may be tested at conditions approaching interim operating conditions simulating run-out and axial movement as determined previously. Seal face run-out will be achieved by shimming the seal and the axial movement by adjusting the seal height to various lengths.

Prior to dynamic testing, the seal will be evaluated on the static rig to measure static film stiffness and establish improved film stiffness of the new design.

Following performance testing at various speed and temperature combinations dictated by the engine cycles, the seal will be tested for endurance for several hundred hours simulating a representative engine cycle.

A hybrid design incorporating both hydrostatic and hydrodynamic face geometry may be considered. Advantages of a hybrid design compared to current hydrostatic stepped face seal will be analyzed in detail. It is anticipated that the seal, designed to run at fairly large film thickness to minimize heat generation, could still gain additional film stiffness from hydrodynamic features at extremely high surface speeds. The hydrodynamic features would also help prevent the rotor from contacting the stator during transient conditions of high run-outs, axial movements and vibrations.

Stein Seal Company's current design code will be modified to include appropriate hydrodynamic face geometry. Modified Reynold's equation for turbulence and choked flow will be incorporated in the design code. A comprehensive Finite Element Analysis code (ANSYS) will be used as a part of the fully iterative design code for fluid structure interactions.

After identifying the critical seal design parameters, such as hydrodynamic features, hydrostatic step dimensions, and the like, the design will be optimized to maximize the film stiffness and minimize heat generation by performing design of experiments (DOE) at the design phase.

Component materials will also be selected for continuous 1500° F. operation in an oxidizing environment. Tribo-pair selection will be based on the results of Task 3.

The new seal size will be determined based on the horsepower and maximum speed capabilities of the rigs; the speed of 1500 ft/sec. will be achieved by rotating the subscale seal at a higher rpm.

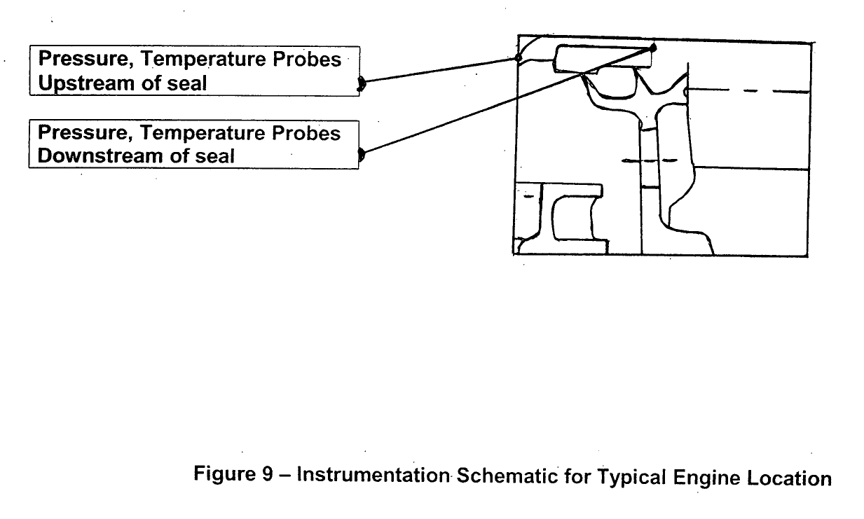

Instrumentation will be used to measure seal pressures and temperatures throughout the test program. Where feasible, instrumentation to directly measure axial and radial movements between rotating and static parts will be installed. Data shall be reduced to calculate seal leakages for comparison against previously acquired data and will be obtained over a range of expansion ratios and speeds. A flow and bearing load program will be used to calculate the seal leakage and determine the overall impact on the engine flow system. The planned instrumentation and run program will be reviewed before installing instrumentation on the hardware and initiating the test program. An instrumentation schematic required for the data validation of the seal at a typical engine location is illustrated in FIG. 9.

The largest risk is to demonstrate the feasibility of achieving the ultimate goal of a non-contacting seal operating at 1500 ft/sec at 1500° F. Non-contacting seals with extremely low leakage are in operation over two decades in industrial gas compressors. However, these seals are designed to operate at much lower temperatures (<400-500° F.) and surface speeds (400-500 ft/sec). Non-contacting sealing technology has not yet been demonstrated in gas turbine engines where design challenges are greater than those for industrial compressors because of much higher operating temperatures and surface speeds.

The proposed non-contact seal design has already been tested at 1000 ft/sec and 1000° F., simulating run-out and pressure conditions approaching those present in a gas turbine engine. Based on these results, the effort will make design enhancements to expand the operating envelope to an interim target of 1200 ft/sec and 1200° F. covering a number of key rotating seal locations in advanced engines and demonstrate this key non-contacting rotating sealing technology in an advanced engine. Details of seal environment, such as run-out, rotor movement, vibration, cannot be exactly simulated on a test rig. Hence, engine testing at interim conditions is deemed to be more important and of a lower technical risk than to focus solely on enhancing the performance envelope for the proof-of-concept of a new design targeting the ultimate goal of 1500 ft/sec and 1500° F. The engine test will also advance the TRL level to 6 leading to fallout applications in advanced military and commercial engines. Therefore, an engine test at an interim condition is given a greater priority than achieving the ultimate goal of 1500 ft/sec and 1500° F.

What is claimed is:

1. An improvement to a hydrostatic seal assembly used between a shaft and a housing to restrict the flow of fluid from a relatively higher pressure region in the housing to a relatively lower pressure region in the housing, comprising:
a seal runner extending radially from the shaft and having a shaft sealing surface; and
a seal ring positioned around the shaft and having a sealing face surface positioned for movement toward and away from the shaft sealing surface and forming a seal gap therebetween to break down the pressure across the seal ring;
wherein the sealing face surface comprises a first edge and a second edge thereon, the first edge being positioned near the higher pressure region and the second edge being positioned near the lower pressure region;
wherein the sealing face surface comprises a plurality of surface sectors, each of the plurality of surface sectors being formed to converge toward the shaft sealing surface along the seal gap in the direction from the first edge toward the second edge to provide a plurality of converging flow paths in the seal gap from said first edge toward said second edge;
wherein the surface sectors join near the second edge to form an annular sealing dam adjacent the second edge;
wherein a plurality of sealing dam spokes extend radially from the annular sealing dam toward the first edge, each of the plurality of sealing dam spokes having a side joining with the sealing face surface to delineate the surface sectors;
wherein the annular sealing dam comprises a dam sealing surface, wherein each of the plurality of sealing dam spokes comprises a dam spoke sealing surface, and wherein the dam sealing surface and each of the dam spoke sealing surfaces are substantially planar with one another; and
wherein the plurality of converging flow paths are positioned to induce increased turbulent flow within the seal gap.
